(19) United States
(12) Patent Application Publication
(10) Pub. No.: US 2008/0167876 A1
(43) Pub. Date: Jul. 10, 2008

(54) METHODS AND COMPUTER PROGRAM PRODUCTS FOR PROVIDING PARAPHRASING IN A TEXT-TO-SPEECH SYSTEM

(75) Inventors: Raimo Bakis, Briarcliff Manor, NY (US); Ellen M. Eide, Tarrytown, NY (US); Wael Hamza, Yorktown Heights, NY (US); Michael A. Picheny, White Plains, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,682

(22) Filed: Jan. 4, 2007

(51) Int. Cl. G10L 21/06

(52) U.S. Cl. 704/260; 704/E21.017

(57) ABSTRACT

A method and computer program product for providing paraphrasing in a text-to-speech (TTS) system is provided. The method includes receiving an input text, parsing the input text, and determining a paraphrase of the input text. The method also includes synthesizing the paraphrase into synthesized speech. The method further includes selecting synthesized speech to output, which includes: assigning a score to each synthesized speech associated with each paraphrase, comparing the score of each synthesized speech associated with each paraphrase, and selecting the top-scoring synthesized speech to output. Furthermore, the method includes outputting the selected synthesized speech.

### BACKGROUND OF THE INVENTION

1. Field of the Invention

This invention relates to speech synthesis, and particularly to methods and computer program products for providing paraphrasing in a text-to-speech system.

2. Description of Background

Before our invention, the quality of text-to-speech (TTS) system output varied greatly depending upon the particular text synthesized. Slight changes in wording can have a dramatic effect on the quality of synthesized speech, because, for example, a bad discontinuity may be avoided. Methods have been considered that rearrange information in a flight-planning scenario for improved TTS quality. For example, a TTS system may rewrite “departing New York and arriving in San Francisco” as “arriving in San Francisco, departing New York.” Although synthesized speech quality may be improved through rearranging words, such methods do not provide a further improvement that may exist when the words are actually changed, rather than just rearranged.

Accordingly, there is a need in the art for a method for providing paraphrasing in a TTS system that overcomes these drawbacks.

### SUMMARY OF THE INVENTION

The shortcomings of the prior art are overcome and additional advantages are provided through the provision of methods and computer program products for providing paraphrasing in a text-to-speech (TTS) system. The method includes receiving an input text, parsing the input text, and determining a paraphrase of the input text. The method also includes synthesizing the paraphrase into synthesized speech. The method further includes selecting synthesized speech to output, which includes: assigning a score to each synthesized speech associated with each paraphrase, comparing the score of each synthesized speech associated with each paraphrase, and selecting the top-scoring synthesized speech to output. Furthermore, the method includes outputting the selected synthesized speech. Alternatively, a user is presented with a set of synthesized paraphrased utterances, from which the user chooses a version that the user prefers. A user may be a developer who picks one of several alternatives to include in a repertory of “prompts” for a given system.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution which improves the quality of synthesized speech in a TTS system by rewording text prior to synthesis. The reworded text may result in more natural sounding speech through avoiding discontinuities or by achieving a better prosody (pitch and duration) contour. A further technical effect includes producing multiple paraphrased options for rephrasing text, thus enabling a selection of a preferred paraphrased option.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a TTS system upon which paraphrasing may be implemented in exemplary embodiments; and

FIG. 2 illustrates one example of a flow diagram describing a process for paraphrasing in a TTS system in exemplary embodiments.

The detailed description explains the preferred embodiments of the invention, together with advantages and features, by way of example with reference to the drawings.

### DETAILED DESCRIPTION OF THE INVENTION

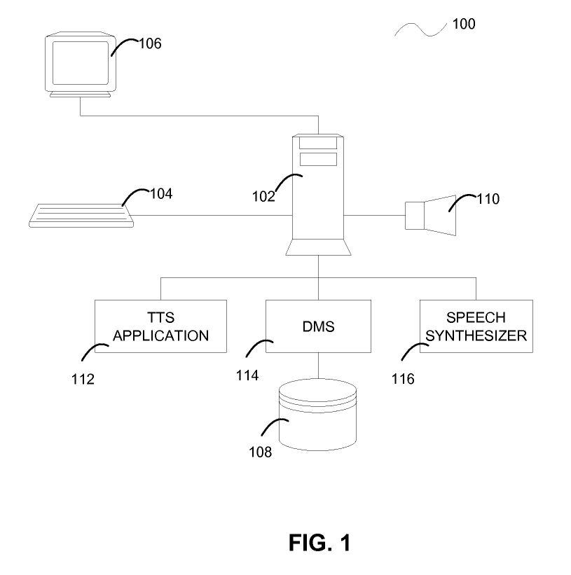

Turning now to the drawings in greater detail, it will be seen that in FIG. 1 there is a block diagram of an exemplary text-to-speech (TTS) system upon which paraphrasing may be implemented. A TTS system converts text into an artificial production of human speech through speech synthesis. The system 100 of FIG. 1 includes a processing system 102, an input device 104, a display device 106, a data storage device 108, and a speech output device 110. The processing system 102 may be a processing component in any type of computer system known in the art. For example, the processing system 102 may be a processing component of a desktop computer, a general-purpose computer, a mainframe computer, or an embedded computer. In exemplary embodiments, the processing system 102 executes computer readable program code. While only a single processing system 102 is shown in FIG. 1, it will be understood that multiple processing systems may be implemented, each in communication with one another via direct coupling or via one or more networks. For example, multiple processing systems may be interconnected through a distributed network architecture. The single processing system 102 may also represent a cluster of processing systems.

The input device 104 may be a keyboard, a keypad, a touch sensitive screen for inputting alphanumerical information, or any other device capable of producing input to the processing system 102. The display device 106 may be a monitor, a terminal, a liquid crystal display (LCD), or any other device capable of displaying output from the processing system 102. The display device 106 may provide a user of the system 100 with text or graphical information. The data storage device 108 refers to any type of storage and may comprise a secondary storage element, e.g., hard disk drive, tape, or a storage subsystem that is external to the processing system 102. Types of data that may be stored in the data storage device 108 include files and databases. It will be understood that the data storage device 108 shown in FIG. 1 is provided for purposes of simplification and ease of explanation and is not to be construed as limiting in scope. To the contrary, there may be multiple data storage devices utilized by the processing system 102. The speech output device 110 may be a speaker, multiple speakers, or any other device capable of outputting synthesized speech.

In exemplary embodiments, the processing system 102 executes various applications, including a TTS application (TTSA) 112, a data management system (DMS) 114, and a speech synthesizer (SS) 116. An operating system and other applications, e.g., business applications, a web server, etc., may also be executed by the processing system 102 as dictated by the needs of the user of the system 100. The TTSA 112 performs paraphrasing of input text in conjunction with the DMS 114, and the SS 116. The DMS 114 may access data and files stored on the data storage device 108, such as look-up tables, foreign language files, and synthesizer files. The SS 116 may synthesize speech based on input received from the TTSA 112. Although the TTSA 112, the DMS 114, and the SS 116 are shown as separate applications executing on the processing system 102, it will be understood by one skilled in the art that the applications may be merged or further subdivided as a single application, multiple applications, or any combination thereof. The details of the process of paraphrasing in a TTS system are further defined herein.

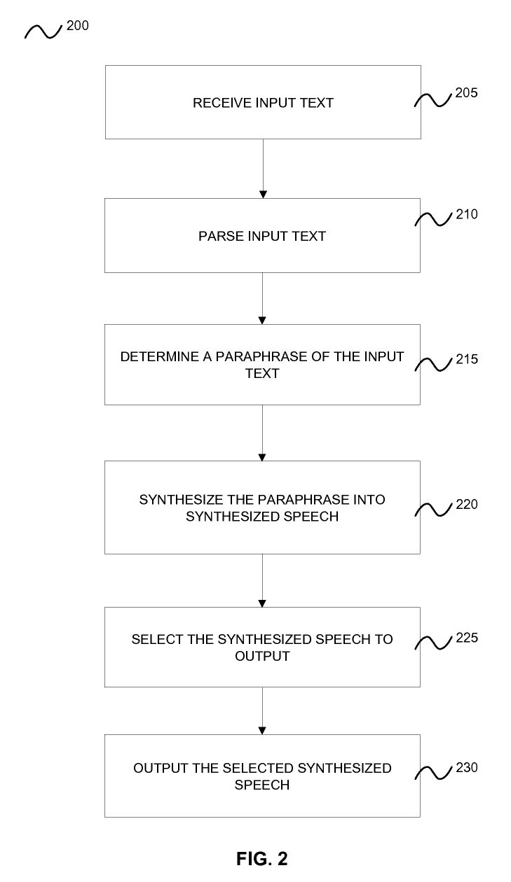

Turning now to FIG. 2, a process 200 for implementing paraphrasing in a TTS system, such as the system 100, will now be described in accordance with exemplary embodiments. At step 205, the TTSA 112 receives input text. In exemplary embodiments, the TTSA 112 may receive input text from the input device 104 through the processing system 102. Alternatively, the TTSA 112 may receive input text from a file stored on the data storage device 108 through the DMS 114. In further exemplary embodiments, the TTSA 112 may receive input text through a data structure populated by another application executing on the processing system 102.

At step 210, the input text is parsed. The TTSA 112 may parse the input text to separate or identify words or phrases that may be paraphrased by an alternate word or phrase. At step 215, a paraphrase of the input text is determined. For any given word or phrase there may be multiple paraphrases possible. To determine a paraphrase, the TTSA 112 may request tables, files, or other information on the data storage device 108 through the DMS 114. The data storage device 108 may hold a look-up table of paraphrases. A list of words or phrases to be paraphrased may appear in the look-up table, along with a set of acceptable paraphrases for each word or phrase. An example entry might be: “want->would like”, which indicates that the words “would like” are an acceptable paraphrase for the word “want.” The TTSA 112 may search the look-up table for a word or phrase in the input text, find a matching entry in the look-up table for the word or phrase in the input text, and return a corresponding paraphrase.

In exemplary embodiments, determining a paraphrase may be performed through the use of a rule. A rule may include a search pattern and a paraphrase replacement pattern. For example, there may be a rule with a search pattern of “any word ending in ‘n apostrophe t’”, and a corresponding paraphrase replacement pattern may be “paraphrase as two words, the part before the final ‘n’ followed by a space, followed by ‘not’”. The TTSA 112 may apply the rule search pattern to the input text, find a word or phrase that matches the rule search pattern, apply the rule paraphrase replacement pattern, and return a paraphrase.

In further exemplary embodiments, a paraphrase may be determined from the input text itself through cross-correlation with a foreign language translation of the input text. For example, books that have been translated into several languages may support cross-correlation between translations. The TTSA 112 may search for and find a word or phrase in the input text, such as “I cannot”. The TTSA 112 may match a word or phrase in a foreign language translation of the input text with the word or phrase in the input text. The TTSA 112 may then search for and find a second instance of the matched word or phrase in the foreign language translation of the input text. The TTSA 112 may match a word or phrase in the input text with the second instance of the matched word or phrase in the foreign language translation of the input text, returning the matched word or phrase in the input text as a paraphrase. For example, a phrase “I cannot” may be translated as “je ne peut pas” in a French language corpus. The TTSA 112 may then search for other instances of “je ne peut pas” in the French corpus, and may find, for example that “I can't” appears in one instance, and “I am unable to” appears in another instance. Thus through cross-correlation of between the input text and foreign language translations of the input text, the TTSA 112 may infer that “I can't” and “I am unable to” are potential paraphrases for the phrase “I cannot”.

In further exemplary embodiments, the TTSA 112 may automatically detect grammatical errors in words or phrases in the input text, and offer the correct version as an alternative paraphrase. For example, if the user of the system 100 requests a synthesis of “Who are you calling?”, the TTSA 112 may determine that the sentence is grammatically incorrect and return a paraphrase of “Whom are you calling?” as an alternative. However, the opposite may also be true. For example, if the user of the system 100 requests a synthesis of “Whom are you calling?”, the TTSA 112 may return the more colloquial “Who are you calling?”, if the paraphrase determination is colloquial with no examples of “Whom”. As illustrated by this example, grammatical errors are relative to the paraphrasing ability of the TTSA 112, and not intended to be construed in an absolute sense.

At step 220, the paraphrase is synthesized into synthesized speech. If the TTSA 112 has determined multiple paraphrases for a word or phrase, the SS 116 may synthesize each paraphrase as synthesized speech. To minimize the computational load, the TTSA 112 may bypass paraphrasing if an original attempt at synthesis produces a good acoustic score. The synthesized speech generated by the SS 116 may be stored to a file on the data storage device 108 through the DMS 114, or returned to the TTSA 112 in a data structure.

At step 225, the synthesized speech is selected to output. Selecting a version of the synthesized speech to output may be done manually or automatically when multiple paraphrases for a word or phrase are determined. In exemplary embodiments, the user of the system 100 may select the desired synthesized speech to output. Alternatively, the TTSA 112 may use a scoring system to select the synthesized speech to output. When multiple paraphrases for a word or phrase are determined, the TTSA 112 may assign a score to each synthesized speech associated with each paraphrase. The score may be a composite of an acoustic score, a semantic score, a grammatical score, and a stylistic score. If the original author of the input text chose his words carefully, then any paraphrase incurs a penalty, as it has at least slightly different semantic or stylistic implications and may even be grammatically incorrect. The composite scoring enables comparisons between collective improvements, as a small improvement in one scoring category may be outweighed by a larger improvement another scoring category, such as the acoustic score. The TTSA 112 may compare the scores, and the top-scoring synthesized speech may be selected to output. At step 230, the selected synthesized speech is output. The selected synthesized speech may be output through the speech output device 110. Alternatively, the selected synthesized speech may be output to a file in the data storage device 108 through the DMS 114, or passed through a data structure to another application executing on the processing system 102.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for paraphrasing in a text-to-speech (TTS) system, comprising:
receiving an input text;
parsing the input text;
determining a paraphrase of the input text;
synthesizing the paraphrase into synthesized speech;
selecting synthesized speech to output, comprising:
assigning a score to each synthesized speech associated with each paraphrase;
comparing the score of each synthesized speech associated with each paraphrase; and
selecting the top-scoring synthesized speech to output; and
outputting the selected synthesized speech.

2. The method of claim 1, wherein determining a paraphrase of the input text is comprised of:
searching a look-up table for a word or phrase in the input text;
finding a matching entry in the look-up table for the word or phrase in the input text; and
returning a corresponding paraphrase.

3. The method of claim 1, wherein determining a paraphrase of the input text is comprised of:
applying a rule search pattern to the input text;
finding a word or phrase that matches the rule search pattern;
applying a rule paraphrase replacement pattern; and
returning a paraphrase.

4. The method of claim 1, wherein determining a paraphrase of the input text is comprised of:
searching for a word or phrase in the input text;
finding the word or phrase in the input text;
matching a word or phrase in a foreign language translation of the input text with the word or phrase in the input text;
searching for a second instance of the matched word or phrase in the foreign language translation of the input text;
finding a second instance of the matched word or phrase in the foreign language translation of the input text;
matching a word or phrase in the input text with the second instance of the matched word or phrase in the foreign language translation of the input text; and
returning the matched word or phrase in the input text as a paraphrase.

5. The method of claim 1, wherein determining a paraphrase of the input text is comprised of:
detecting a grammatical error in a word or phrase in the input text;
determining alternate grammar for the word or phrase in the input text; and
returning the alternate grammar as a paraphrase.

6. The method of claim 1, wherein the score is a composite value comprising:
an acoustic score;
a semantic score;
a grammatical score; and
a stylistic score.

7. A computer program product for paraphrasing in a text-to-speech (TTS) system, the computer program product including instructions for implementing a method, comprising:
receiving an input text;
parsing the input text;
determining a paraphrase of the input text;
synthesizing the paraphrase into synthesized speech;
selecting synthesized speech to output, comprising:
assigning a score to each synthesized speech associated with each paraphrase;
comparing the score of each synthesized speech associated with each paraphrase; and
selecting the top-scoring synthesized speech to output; and
outputting the selected synthesized speech.

8. The computer program product of claim 7, wherein determining a paraphrase of the input text is comprised of:
searching a look-up table for a word or phrase in the input text;
finding a matching entry in the look-up table for the word or phrase in the input text; and
returning a corresponding paraphrase.

9. The computer program product of claim 7, wherein determining a paraphrase of the input text is comprised of:
applying a rule search pattern to the input text;
finding a word or phrase that matches the rule search pattern;
applying a rule paraphrase replacement pattern; and
returning a paraphrase.

10. The computer program product of claim 7, wherein determining a paraphrase of the input text is comprised of:
searching for a word or phrase in the input text;
finding the word or phrase in the input text;
matching a word or phrase in a foreign language translation of the input text with the word or phrase in the input text;
searching for a second instance of the matched word or phrase in the foreign language translation of the input text;
finding a second instance of the matched word or phrase in the foreign language translation of the input text;
matching a word or phrase in the input text with the second instance of the matched word or phrase in the foreign language translation of the input text; and
returning the matched word or phrase in the input text as a paraphrase.

11. The computer program product of claim 7, wherein determining a paraphrase of the input text is comprised of:
detecting a grammatical error in a word or phrase in the input text;
determining alternate grammar for the word or phrase in the input text; and
returning the alternate grammar as a paraphrase.

12. The computer program product of claim 7, wherein the score is a composite value comprising:
an acoustic score;
a semantic score;
a grammatical score; and
a stylistic score.
